(19) United States
(12) Patent Application Publication
(10) Pub. No.: US 2024/0037013 A1
(43) Pub. Date: Feb. 1, 2024

(54) COMPUTER-IMPLEMENTED METHOD FOR VERIFYING A SOFTWARE COMPONENT OF AN AUTOMATED DRIVING FUNCTION

(71) Applicant: Robert Bosch GmbH, Stuttgart (DE)

(72) Inventors: Michael Messer, Adolzfurt (DE); Lukas Koenig, Grossbottwar (DE); Michael Hanselmann, Korntal-Muenchingen (DE)

(21) Appl. No.: 18/353,366

(22) Filed: Jul. 17, 2023

(30) Foreign Application Priority Data
Jul. 26, 2022 (DE) 10 2022 207 611.7

(51) Int. Cl. G06F 11/36; B60W 60/00

(52) U.S. Cl. CPC G06F 11/3608; B60W 60/00

(57) ABSTRACT

A computer-implemented method for verifying a software component of an automated driving function, The method includes: translating the native program code into a model checker representation of the software component to be verified and analyzing the model checker representation of the software component to be verified using a model checking method. The native program code of the software component to be verified is analyzed to identify independent sequences of commands, wherein an independent sequence of commands is a cohesive succession of program commands by which at least two variables are set, and the at least one result of an independent sequence of commands is independent of the order in which its program commands are processed. The variables of the at least one independent sequence of commands of the native program code are then simultaneously set in the model checker representation of the software component to be verified.

### CROSS REFERENCE

The present application claims the benefit under 35 U.S.C. § 119 of German Patent Application No. DE 10 2022 207 611.7 filed on Jul. 26, 2022, which is expressly incorporated herein by reference in its entirety.

### FIELD

The present invention relates to a computer-implemented method for verifying a software component of an automated driving function, in which the native program code of the software component to be verified is limited to a set of operations of the programming language used that are defined as permissible. A prerequisite for an operation to be defined as permissible in the context of the present invention is that this operation can be represented as a finite automaton.

### BACKGROUND INFORMATION

A verification method of the type described here comprises the following steps:
a. translating the native program code into a model checker representation of the software component to be verified and
b. analyzing the model checker representation of the software component to be verified using a model checking method.

As part of the industrial process for developing software components of an automated driving function, such as action planners, fusion algorithms, and other control modules, the correctness of the implementation needs to be checked. Generally speaking, this check is currently test-based; for example, methods such as simulation-based testing or replay hardware-in-the-loop (HIL) solutions are used. However, as a rule, test-based methods do not guarantee that errors are discovered or that the tested software component always provides error-free results in respect of predefined requirements and boundary conditions.

The scientific literature describes techniques and tools for model checking and probabilistic model checking. A model checker checks all the configuration options for a piece of software or a model of the software against a mathematically precisely formulated requirement. In the process, a check is performed as to whether all the possible configurations of the software meet this requirement. This can provide formal mathematical proof of whether the software or the model of the software is error-free in relation to the formulated requirement. At this juncture, reference is made to Spin (http://spinroot.com/spin/whatispin.html) and NuSMV (http://nusmv.fbk.eu/) as examples of model checking tools.

To apply the conventional model checking tools, the native program code of the software component to be verified needs to be translated into a model checker representation, i.e., into an input model that the model checker can use. In view of the scope and complexity of software components of an automated driving function, this translation should as far as possible take place automatically. In addition, the reference to the program structure of the native program code should be retained during the translation. This is important in particular in the industrial software component development process. That is because any errors discovered in the model checker representation can be attributed to specific operations or program commands of the native program code, and therefore error causes in the native program code can also be remedied. In this regard, it has furthermore proven advantageous if the translation of the native program code into a model checker representation is optimized also in terms of the time and space required for the model checking.

### SUMMARY

According to the present invention, it is provided first to analyze the native program code in order to identify independent sequences of commands. An independent sequence of commands consists of a cohesive succession of program commands by which at least two variables are set. In addition, a sequence of commands is independent when the at least one result of the sequence of commands is independent of the order in which its program commands are processed. According to the present invention, the variables of the at least one sequence of commands of the native program code that is identified as being independent are simultaneously set in the model checker representation of the software component to be verified.

According to an example embodiment of the present invention, sequences of program commands of the native program code for which the order of processing is “immaterial” are identified. In said so-called independent sequences of commands, therefore, the order of the program commands can be swapped at will without influencing the result in the process. According to the present invention, it has been found that the variables of an independent sequence of commands of this kind can be simultaneously set in the model checker representation, thereby significantly reducing the time needed for the model checking.

Moreover, simultaneously setting the variables reduces the path length through the model graph and thus the space required for the model checking.

In a particularly advantageous development of the method according to the present invention, when the native program code is analyzed, not only are independent sequences of commands identified, but so too are independently atomic sequences of commands. A sequence of commands is deemed independently atomic if it is independent and the property of independence would be lost if at least one further program command of the native program code were added. In other words, an independently atomic sequence of commands is a cohesive succession, of maximum length, of program commands that can be processed in any order without changing the result of that sequence of commands. By simultaneously setting all the variables of an independently atomic sequence of commands, a maximum amount of time can be saved during the model checking, and the space required for the model graph can be optimized too.

Advantageously, the native program code of the software component to be verified is converted into a finite automaton (FA), the states and state transitions of which can be uniquely assigned to the code structure of the native program code. The model checker representation can then be generated in a simple manner on the basis of this finite automaton such that the code structure of the native program code is substantially retained when the native program code is translated into the model checker representation. As already mentioned, retaining the code structure of the native program code in the model checker representation is an essential prerequisite for a meaningful use of model checking tools for verifying software components for automated driving functions, in particular also as part of the development process. In this way, errors discovered during the model checking can be unequivocally traced back to certain operations or instructions of the native program code and thus can be unequivocally and durably remedied.

In view of the size and complexity of the software components of an automated driving function, it has often proven advantageous to convert the native program code into a finite automaton in a plurality of steps. In such a variant of the method according to the present invention, in at least one first step, an intermediate representation of the native program code is generated. This first conversion step is also called mining hereinafter. To do this, certain selected FA-like program structures in the native program code are automatically detected in order to then automatically assign corresponding FA states and FA state transitions to the detected program structures. The resulting intermediate representation of the native program code has the structure of a finite automaton, referred to as FA segments of the intermediate representation. The remaining parts of the native program code, i.e., all the program structures that have not been converted during the mining, are embedded in the FA segments. They are referred to as code segments of the intermediate representation. Because the native program code is limited to a set of permissible operations of the programming language used, these code segments can then also be converted into FA segments in at least one further conversion step. In any case, all the elements of the native program code to be mined are also contained in the intermediate representation, namely the automatically detected FA-like structures in the form of FA segments, but also more complex structures, such as loops, in the form of code segments.

In the simplest case, the mining is reduced to simply mapping program structures of one or more types of the native program code to structures of the intermediate representation. In a preferred variant of the mining, FA-like structures of the “switch case” instruction type are detected in order to assign a distinct FA state and at least one state transition between FA states to each “case” component of a detected “switch case” instruction. The mining of finite automata on the basis of “switch case” instructions is advantageous in several respects. First of all, a very large number of program functions can be represented in the form of “switch case” instructions and, second of all, it is very simple to assign a “switch case” instruction to FA states and FA state transitions.

The crucial aspect is that this gradual conversion in each conversion step allows the code structure of the native program code to be uniquely assigned to the states and state transitions of the intermediate representation and of the resulting finite automaton. It is particularly advantageous that this approach is independent of the programming language of the native program code, at least for all standard procedural, object-oriented, and functional programming languages, such as C++, Python, and Java, which are typically used for implementing automated driving functions.

It is particularly advantageous to use the measures according to the present invention when converting the code segments of an intermediate representation into FA segments. For this purpose, the code segments of the intermediate representation are analyzed in order to identify independent and/or independently atomic sequences of commands and convert them into FA segments. For this purpose, an FA state of the intermediate representation, which FA state comprises code segments having at least two independent and/or independently atomic sequences of commands, is split into at least two sub-states, a distinct sub-state being assigned to each independent or independently atomic sequence of commands.

In many cases, the automatic detection of independent and/or independently atomic sequences of commands of the native program code can be improved by optimizing the native program code prior to the conversion into a finite automaton. To do this, compilers can be used, for example, which effectively simplify the program structure of the native program code.

### BRIEF DESCRIPTION OF THE DRAWINGS

Advantageous specific embodiments and developments of the present invention are explained hereinafter with reference to the figures.

FIG. 1 is a block diagram of a computer-implemented system or program product 10 according to an example embodiment of the present invention for verifying a software component of an automated driving function.

FIG. 2 illustrates the translation of the native program code of a software component to be verified into a model checker representation as part of the variant of the verification method according to the present invention shown in FIG. 1.

### DETAILED DESCRIPTION OF EXAMPLE EMBODIMENTS

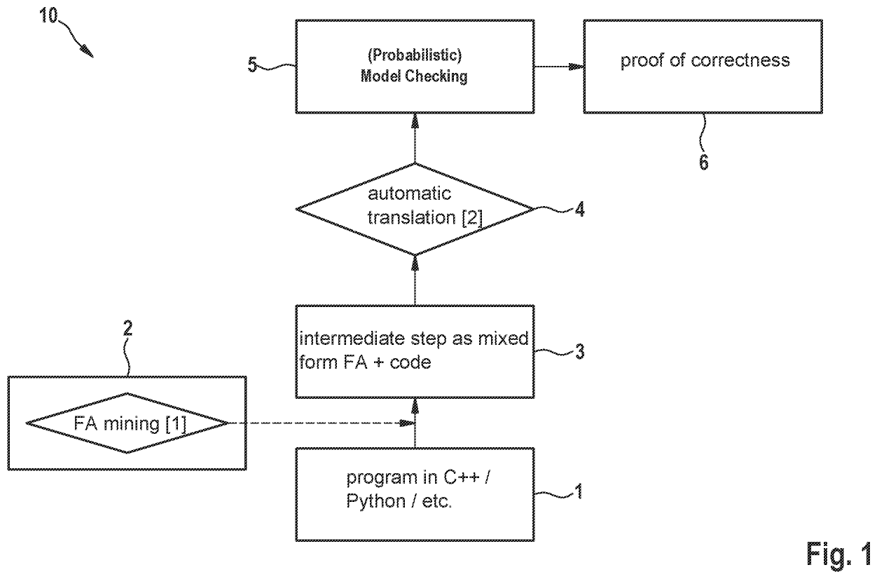

As already explained above, the present inventions provide measures which make it possible to use model checking to verify software components of an automated driving function, in particular also during the development process. Accordingly, the computer-implemented system 10 according to the present invention shown in FIG. 1 provides that the native program code 1 of a software component to be verified is first translated into a model checker representation of the software component to be verified and this model checker representation is then analyzed using a model checking method (block 5), in order to demonstrate the correctness of the software component or to identify errors in the native program code 1 (block 6).

A prerequisite for fully automating the translation of the native program code into a model checker representation is that the native program code only contains operations that can themselves be represented as a finite automaton. Therefore, to apply the verification method according to the present invention, rather than using all the available operations of the relevant programming language when developing the native program code, it is possible to use only a subset of the available operations. For C++ or Python programs, for this purpose, all the loop/GoTo/recursion structures are dispensed with, for example.

The native program code is first converted into a finite automaton (FA), the states and state transitions of which can be uniquely assigned to the code structure of the native program code, in order to then generate a model checker representation on the basis of this finite automaton such that the code structure of the native program code is substantially retained when the native program code is translated into the model checker representation.

At this point, it should be noted that, in certain cases, the thus generated finite automaton can already be used as a model checker representation, i.e., as an input for the model checker. In these cases, a further translation step is not required.

In the exemplary embodiment according to FIG. 1, the native program code 1 is converted into a finite automaton in two steps. In the first step, known as mining (block 2), FA-like structures of a certain type are detected in the native program code. Corresponding FA states and FA state transitions are assigned to the automatically detected FA-like program structures, likewise automatically. In the process, an intermediate representation 3 of the native program code is generated. This intermediate representation 3 already has the structure of a finite automaton, in which the structure of the native program code is retained, however. The remaining parts of the native program code are embedded in the FA structure of the intermediate representation 3. In a further step 4, these “code segments” of the intermediate representation 3 are then likewise automatically converted into FA segments. In the process, a finite automaton is generated which represents the native program code in its entirety and in which the structure of the native program code is retained. This finite automaton can then either be translated into a model checker representation or be directly used for the model checking in block 5.

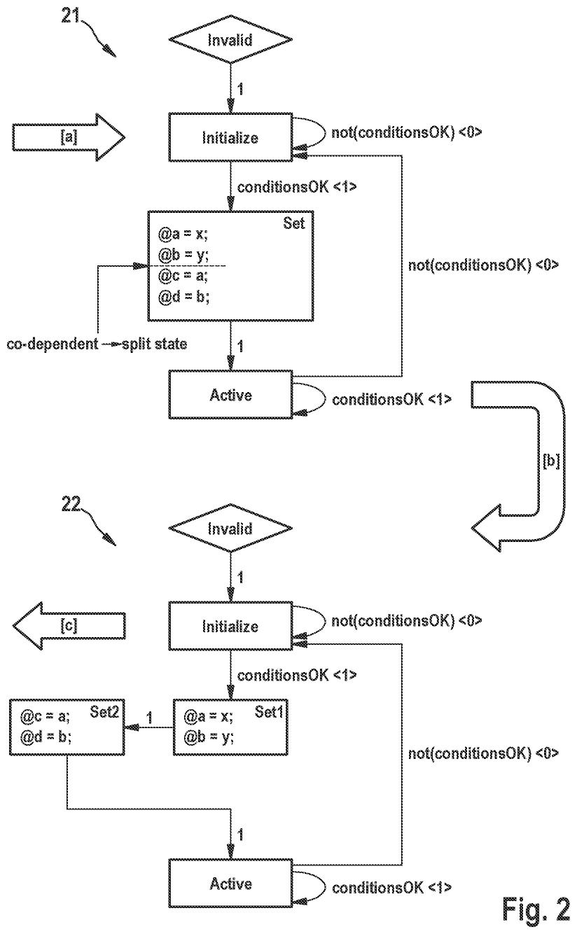

The two-stage conversion of the native program code of a software component to be verified into a finite automaton is explained in more detail in conjunction with FIG. 2, in particular the second conversion step 2 in which the code segments of the intermediate representation 3 are converted into FA segments.

The translation process begins with native program code, for example in C++, which has been converted into an intermediate representation 21 by mining in a first conversion step (indicated in this case by the arrow a), said intermediate representation already having the structure of a finite automaton. The code segment of the intermediate representation 21 is already limited to “FA-like” structures by the mining process. This means that, in the intermediate representation, in addition to the usual arithmetic-logic-comparative functions such as “+”, “&”, and “≤”, only the following operations should be performed:
if-then-else,
composition, and
setting of variables.

In the exemplary embodiment being described here, the intermediate representation comprises, as FA elements, the FA states “Initialize”, “Set”, and “Active”, as well as state transitions having activation conditions in the form of the binary state variables (conditionsOK). Moreover, the intermediate representation comprises code segments in the “Set” state, namely the sequence of commands:
@a=x
@b=y
@c=a
@d=b.

In a further conversion step (indicated by the arrow b), these code segments of the intermediate representation 21 are transformed into FA segments likewise automatically, in order to generate the finite automaton 22. For this purpose, the native program code was first analyzed in the “Set” state. In this case, two independently atomic sequences of commands were identified, namely a first sequence of commands: @a=x; @b=y and a second sequence of commands: @c=a; @d=b. In both the first sequence of commands and the second sequence of commands, the order in which the individual program commands are processed does not affect the result(s) of each sequence of commands; in other words, the results of the two sequences of commands are independent of the order in which their program commands are processed. Thus, both sequences of commands meet the independence requirement. However, the order of the sequences of commands has to be retained, i.e., the first sequence of commands has to be processed before the second sequence of commands, since the second sequence of commands accesses the results of the first sequence of commands. Since neither of the two sequences of commands can be extended by further program commands of the native program code without losing the property of independence, both of the sequences of commands in this case are independently atomic.

Next, the “Set” state of the intermediate representation 21 was split into the two sub-states “Set1” and “Set2” of the finite automaton 22. The first sequence of commands was assigned to the sub-state “Set1”, and the second sequence of commands was assigned to the sub-state “Set2”.

Just as the intermediate representation 21 provides state transitions between the states “Initialize” and “Set” and between “Set” and “Active”, the finite automaton 22 comprises state transitions between the state “Initialize” and the sub-state “Set1”, between the sub-states “Set1” and “Set2”, and between the sub-state “Set2” and the state “Active”.

The resulting finite automaton 22 forms the basis for a model checker representation of the native program code, for example for the NuSMV model checker. In this case, it is essential that the variables of the two independently atomic sequences of commands of the native program code can be simultaneously set in the model checker representation. The conversion into the model checker representation is indicated by the arrow c in FIG. 2.

To explain the advantages of the measures according to the present invention, the following is noted:

The intermediate representation in the exemplary embodiment being described here could also be transformed into model checker code by program counter (PC) emulation. This means that the order of the commands of a state in the model checker is emulated by a numerical variable “pc” in order to ensure, for example, that “b=y” (pc=0) is executed after “a=x” (pc=1) in the above example. As explained above, however, the end values of the variables need not necessarily be dependent on that order. If “b=y” is executed before “a=x”, the end result remains the same. Thus, for independently atomic sequences of commands, no PC is needed to ensure proper processing in the model checker.

Instead, the native, highly efficient mechanism of model checkers can be used, according to which a series of variables can be simultaneously set.

By way of example, the following can be written for the NuSMV model checker:
//Context
next(a)=x;
next(b)=y;
//EO Context

This specifies that in a particular “context,” the value of a is set to x, and the value of b is set to y, in the next step. Both allocations occur simultaneously in one step. By contrast, processing using a PC could, for instance, read as follows:
//Context
next(a)=case pc==0: x; TRUE: a;
next(b)=case pc==1: y; TRUE: b;
//EO Context
next(pc)=case pc<MAX: pc+1; TRUE: 0;

Whereas the effect of the allocations is the same, the PC method requires an additional variable and more processing steps compared with the approach according to the present invention.

By contrast, efficiency can be increased using the measures according to the present invention since the time and space required for the model checking is reduced, specifically in two respects:
1. Omitting the variable “pc” entails a reduction in the state space by the factor pc, which corresponds to the length of the longest sequence of commands in any state.
2. Simultaneously setting the variables reduces the path length through the model graph in each case by the factor of the length of the independently atomic sequences.

If the proportion of independently atomic sequences is significant, the second point specifically can bring about huge efficiency gains in “bounded model checking”, because in this case errors are searched for as the path length increases and longer paths entail exponentially increasing runtimes. Together, though, both points should lead to considerable efficiency gains for all model checking forms.

The extent of the efficiency gains ultimately depends on the length of the independently atomic sequences.

It is particularly advantageous to use the method according to the present invention in the verification of software components for safety-critical applications having large state spaces which can only be partially covered by testing alone. This relates in particular to driver assistance systems and highly automated driving functions, robots, aircraft controllers, autonomous ships, etc. For instance, using the method according to the present invention, the correctness of individual system components, such as an action planner or another control module, can be checked as early as in the design period or during development. The method according to the present invention is characterized by:
Complete provability of requirements, i.e., predefined requirements and boundary conditions.
Applicability to all standard procedural, object-oriented, and functional programming languages, such as C++, Python, Java, etc.
Compatibility with different model checkers. The method generates code which can be processed by different model checkers. As a result, in particular complete proof is possible over high-dimensional state spaces using symbolic model checkers.
Fully automated tooling for continuous integration. The method is fully automated and can thus be integrated in a continuous integration pipeline.
Explainability, i.e., user-friendly human-readable outputs on all intermediate layers for debugging, etc. The entire process, from the native code to the model checker, operates with intermediate steps that correspond to one another in structure. Each step can be performed and tested separately.
The two intermediate steps can be visualized during the execution.
The “counterexample” of model checking (if a tested property is not applicable) can be visualized in both the subdivided and the non-subdivided version of the FA (“counterexample replay”).
Since the intermediate steps are structurally identical, any errors discovered in the “counterexample” can be automatically attributed to associated defective lines of code.

What is claimed is:

1. A computer-implemented method for verifying a software component of an automated driving function, native program code of the software component to be verified being limited to a set of operations of the programming language used that are defined as permissible, the method comprising the following steps:
a) translating the native program code into a model checker representation of the software component to be verified; and
b) analyzing the model checker representation of the software component to be verified using a model checking method;
wherein the native program code of the software component to be verified is analyzed in order to identify independent sequences of commands, each of the independent sequences including a cohesive succession of program commands by which at least two variables are set, and at least one result of each independent sequence of commands being independent of an order in which its program commands are processed, and
wherein the variables of the at least one independent sequence of commands of the native program code are simultaneously set in the model checker representation of the software component to be verified.

2. The method as recited in claim 1, wherein independently atomic sequences of commands are identified when the native program code is analyzed, a sequence of commands being deemed independently atomic when the sequence is independent and when a property of independence would be lost if at least one further program command of the native program code were added.

3. The method as recited in claim 1, wherein the native program code is converted into a finite automaton (FA), states and state transitions of finite automaton being uniquely assigned to a code structure of the native program code, and the model checker representation is generated based on the finite automaton such that the code structure of the native program code is substantially retained when the native program code is translated into the model checker representation.

4. The method as recited in claim 3, wherein in at least one first step, FA-like structures are detected in the native program code, corresponding FA states and FA state transitions being assigned to the FA-like structures, and an intermediate representation of the native program code is thus generated, the intermediate representation having a structure of a finite automaton (FA segments) in which remaining parts of the native program code (code segments) are embedded.

5. The method as recited in claim 4, wherein in at least one further step, the code segments of the intermediate representation are analyzed in order to identify independent and/or independently atomic sequences of commands and convert them into FA segments.

6. The method as recited in claim 5, wherein an FA state of the intermediate representation, which FA state includes code segments having at least two independent and/or independently atomic sequences of commands, is split into at least two sub-states, a distinct sub-state being assigned to each independent or independently atomic sequence of commands.

7. The method as recited in claim 3, wherein the native program code of the software component to be verified is optimized before being converted into a finite automaton to simplify the program structure of the native program code.

8. A non-transitory computer-readable medium on which is stored a computer program for verifying a software component of an automated driving function, native program code of the software component to be verified being limited to a set of operations of the programming language used that are defined as permissible, the computer program, when executed by a computer, causing the computer to perform the following steps:
a) translating the native program code into a model checker representation of the software component to be verified; and
b) analyzing the model checker representation of the software component to be verified using a model checking method;
wherein the native program code of the software component to be verified is analyzed in order to identify independent sequences of commands, each of the independent sequences including a cohesive succession of program commands by which at least two variables are set, and at least one result of each independent sequence of commands being independent of an order in which its program commands are processed, and
wherein the variables of the at least one independent sequence of commands of the native program code are simultaneously set in the model checker representation of the software component to be verified.

9. A computer-implemented system for verifying a software component of an automated driving function, native program code of the software component to be verified being limited to a set of operations of the programming language used that are defined as permissible, the system configured to:
a) translate the native program code into a model checker representation of the software component to be verified; and
b) analyze the model checker representation of the software component to be verified using a model checking method;
wherein the native program code of the software component to be verified is analyzed in order to identify independent sequences of commands, each of the independent sequences including a cohesive succession of program commands by which at least two variables are set, and at least one result of each independent sequence of commands being independent of an order in which its program commands are processed, and
wherein the variables of the at least one independent sequence of commands of the native program code are simultaneously set in the model checker representation of the software component to be verified.
